(19) United States
(12) Patent Application Publication
(10) Pub. No.: US 2012/0291095 A1
(43) Pub. Date: Nov. 15, 2012

(54) INDEPENDENT SECURE ELEMENT MANAGEMENT

(75) Inventors: Siva G. Narendra, Portland, OR (US); Donald Allen Bloodworth, Camas, WA (US); Todd Raymond Nuzum, Omaha, NE (US); Prabhakar Tadepalli, Bangalore (IN)

(73) Assignee: TYFONE, INC., Portland, OR (US)

(21) Appl. No.: 13/104,965

(22) Filed: May 10, 2011

(51) Int. Cl. G06F 21/00; G06F 15/16

(52) U.S. Cl. 726/3

(57) ABSTRACT

An independent secure element manager (ISEM) routes secure payloads without modifying the secure payloads and without knowledge of the encryption keys used to encrypt the secure payloads. Secure payloads from multiple issuers and multiple TSMs can coexist in one or more secure elements because of control by the ISEM.

### FIELD

The present invention relates generally to secure elements in electronic devices, and more specifically to management of secure elements.

### BACKGROUND

FIG. 1 shows a prior art smart card. Smart card 100 includes a secure element 110 with secure payload 112. Smart card 100 also includes contacts 120. Smart card 100 is issued to a person (John Q. Public) by an entity such as a bank, a government agency, or a corporation, and may be used for financial transactions, identity, access, or the like. The secure payload 112 may include applications, credit card information, a passport or other identity documents, an access application, or the like. The secure payload 112 is typically encrypted in a manner that allows decryption during a transaction. For example, the secure payload might include encrypted credit card information that can be decrypted by a specific module or modules of a payment processing network, such as a point-of-sale reader.

FIG. 2 shows information flow when issuing a smart card to a consumer in accordance with the prior art. Issuer 210 may be a bank, a government agency, a corporation, or any other entity. Trusted service manager (TSM) 220 is an entity trusted by issuer 210. TSM 220 typically provides services associated with provisioning a secure payload on smartcard 100 on behalf of issuer 210. TSM 220 may also be referred to as a personalization bureau, or “perso bureau.” After TSM 220 loads the secure payload on smart card 100, the card is issued to consumer 230. Consumer 230 may use smart card 100 for financial transactions, for identity purposes, for access to buildings, or any other suitable purpose. In the prior art of FIG. 2, one issuer issues one card with one secure payload to one consumer.

FIG. 3 shows information flow when issuing multiple smart cards to a consumer in accordance with the prior art. Three issuers 310, 320, and 330, provide secure payloads to three separate TSMs 312, 322, and 332, which then load the secure payloads on three separate smart cards 314, 324, and 334. In FIG. 3, different payloads for each issuer are identified by different shapes (circle, square, triangle) within the locks that represent the payloads. Encryption of payloads with different keys is shown by different hatch patterns within the different shapes. Card manufacturers, issuers, TSMs, and other entities may encrypt the payload using the same or different keys. Various keys used may be referred to as transport keys, card manager keys (CMK), application keys, data keys, or the like.

### BRIEF DESCRIPTION OF THE DRAWINGS

FIG. 1 shows a prior art smart card;

FIG. 2 shows information flow when issuing a smart card to a consumer in accordance with the prior art;

FIG. 3 shows information flow when issuing multiple smart cards to a consumer in accordance with the prior art;

FIG. 4 shows an independent secure element manager (ISEM) routing secure payloads to a smart card;

FIG. 5 shows an independent secure element manager (ISEM) controlling access to a secure element in a mobile device;

FIGS. 6 and 7 show flowcharts of methods in accordance with various embodiments of the present invention;

FIG. 8 shows independent secure element management (ISEM) communications;

FIG. 9 shows the use of fixed router path control values (RPCVs);

FIG. 10 shows an independent secure element manager (ISEM) controlling access to multiple secure elements in a mobile device;

FIG. 11 shows an independent secure element manager (ISEM) controlling access by multiple TSMs to multiple secure elements in a mobile device;

FIG. 12 shows an ISEM router modeled as a cross-point switch;

FIG. 13 shows multiple secure elements provisioned with multiple secure payloads;

FIG. 14 shows a universal serial bus (USB) device with an ISEM router and multiple secure elements in accordance with various embodiments of the present invention;

FIG. 15 shows a memory card with an ISEM router and multiple secure elements in accordance with various embodiments of the present invention;

FIG. 16 shows a mobile device with an ISEM router and multiple secure elements in accordance with various embodiments of the present invention;

FIG. 17 shows a subscriber identity module (SIM) with an ISEM router and multiple secure elements in accordance with various embodiments of the present invention;

FIG. 18 shows a provisioning model in which router interface functions are included in a mobile device;

FIG. 19 shows a provisioning model in which router interface functions are included in an ISEM;

FIG. 20 shows a provisioning model in which router interface functions are included in mobile devices; and

FIG. 21 shows a provisioning model in which router interface functions are included in an ISEM.

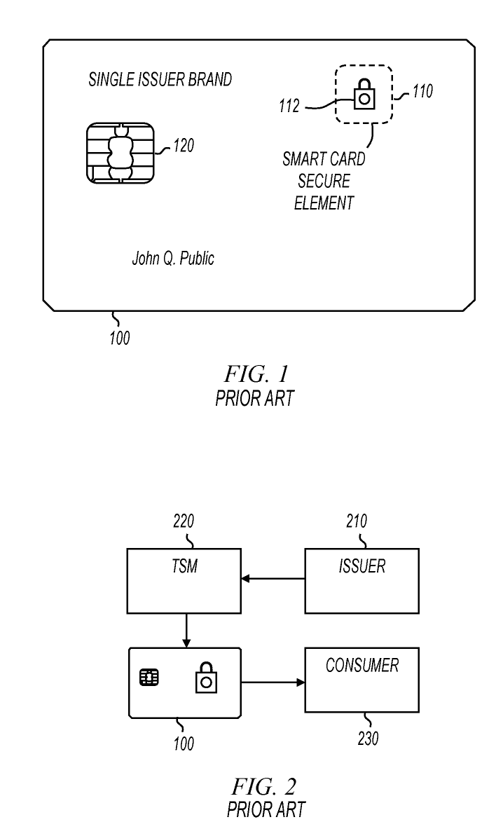

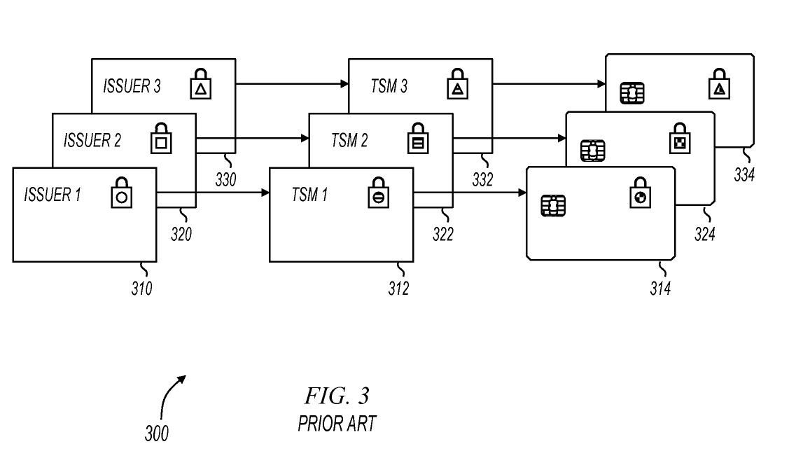

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

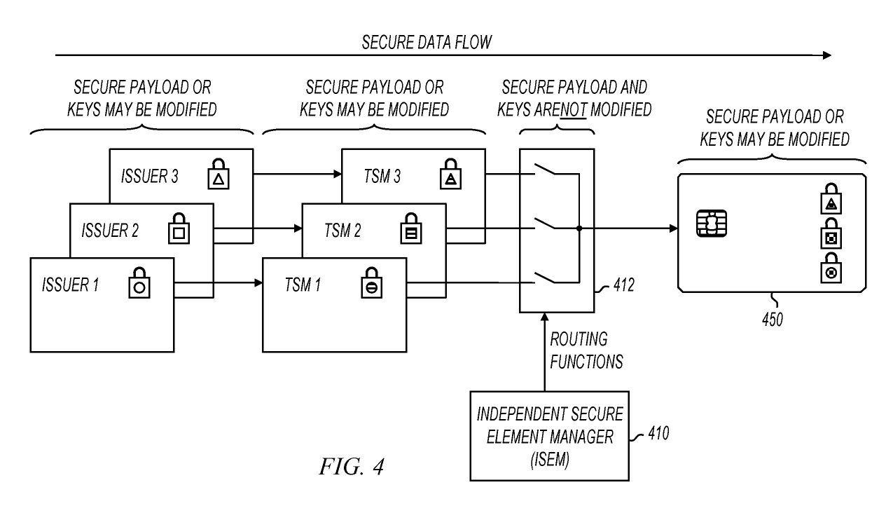

FIG. 4 shows an independent secure element manager (ISEM) routing secure payloads to a smart card. In the example of FIG. 4, three issuers and three TSMs produce secure payloads to be provisioned into a single secure element within smart card 450. Various embodiments of the present invention introduce the concept of independent secure element management whereby an independent third party (ISEM 410) controls access to the secure element. In contrast to issuers and TSMs where encryption keys are employed and possibly modified, ISEM 410 routes encrypted payloads without modifying these secure payloads or having access to the encryption keys.

ISEM 410 controls router 412, and either allows or denies access to the secure element in smart card 450 based on various criteria. As shown in FIG. 4, the secure data flow begins with the issuers on the left and moves right to the secure element in smart card 450. ISEM 410 controls the routing of the secure data flow without being part of the secure data generation or modification. This has several implications. For example, ISEM 410 can control access to the secure element without needing access to encryption keys and without taking on the associated fraud liability. Also for example, as a third party separate from issuers and TSMs, ISEM 410 can enforce secure element access policies that dictate which issuers and TSMs get access to the secure element without any one issuer or TSM controlling secure element access to the detriment of the remaining issuers and TSMs. One advantage to independent secure element management is that consumers can have one smart card with multiple secure payloads (payment, identity, access, etc.), where access to the secure element is not controlled by any of the issuers or TSMs.

Router 412 may be implemented in any fashion without departing from the scope of the present invention. In some embodiments, router 412 is a hardware controller resident on smart card 450. In other embodiments, router 412 is a hardware controller separate from smart card 450. In other embodiments, router 412 includes a processor that executes software instructions. Various other embodiments of router 412 are described in further detail below.

ISEM 410 represents a business entity that controls access to secure elements, and also represents databases and servers that store and operate on information describing which TSMs are allowed access to secure elements and for what purpose.

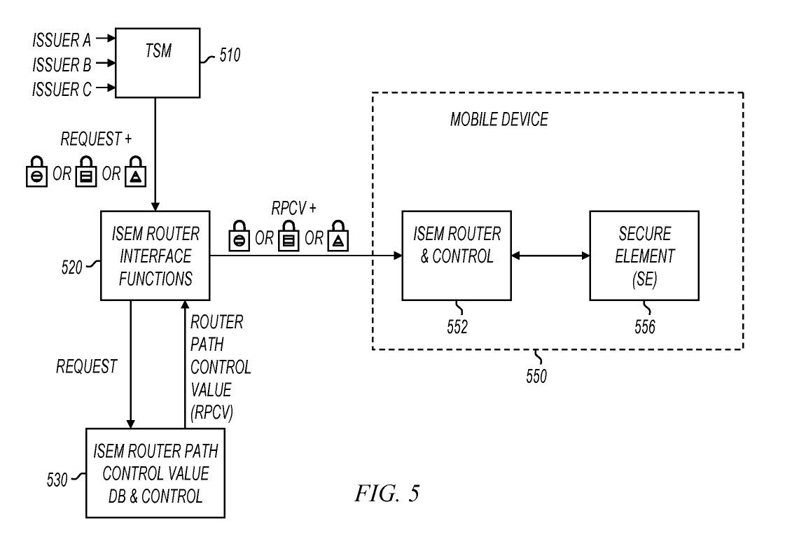

FIG. 5 shows an independent secure element manager (ISEM) controlling access to a secure element in a mobile device. Mobile device 550 includes ISEM router and control component 552 and secure element 556. In some embodiments, secure element 556 may be a smart card controller that includes a secure element or functions as a secure element. Examples of smart card controllers are the “SmartMX” controllers sold by NXP Semiconductors N.V. of Eindhoven, The Netherlands. In some embodiments, secure element 556 has an ISO/IEC 7816 compatible interface that communicates with ISEM router and control component 552, although this is not a limitation of the present invention. Further, in some embodiments, secure element 556 has an ISO/IEC 14443 contactless interface.

In some embodiments, mobile device 550 also includes ISEM router interface functions 520. For example, ISEM router interface functions 520 may be implemented as part of an application programming interface (API) on mobile device 550. In other embodiments, ISEM router interface functions 520 may be resident at the ISEM along with ISEM router path control value (RPCV) database and logic 530.

In the example of FIG. 5, TSM 510 works with three issuers that each wish to provision a secure payload into secure element 556. TSM 510 does not have direct access to the secure element; rather, TSM 510 requests access to the secure element and the ISEM determines whether or not to grant that access.

In operation, TSM 510 sends a request and a secure payload to ISEM router interface functions 520. ISEM router interface functions 520 forwards the request to ISEM RPCV database and logic 530. In response to the request, ISEM RPCV database and logic 530 returns an RPCV to ISEM router interface functions 520. ISEM router interface functions 520 then forwards the RPCV and the secure payload to ISEM router and control component 552. ISEM router and control component 552 determines whether (or where) to forward the secure payload based on the RPCV.

As shown in the example system of FIG. 5, the ISEM plays a role controlling access to the secure element. The ISEM controls access to the secure element without managing encryption keys, and without taking on the fraud liability associated with key management. Further, access control by an ISEM provides scalability when multiple TSMs wish to access the same secure element or multiple secure elements.

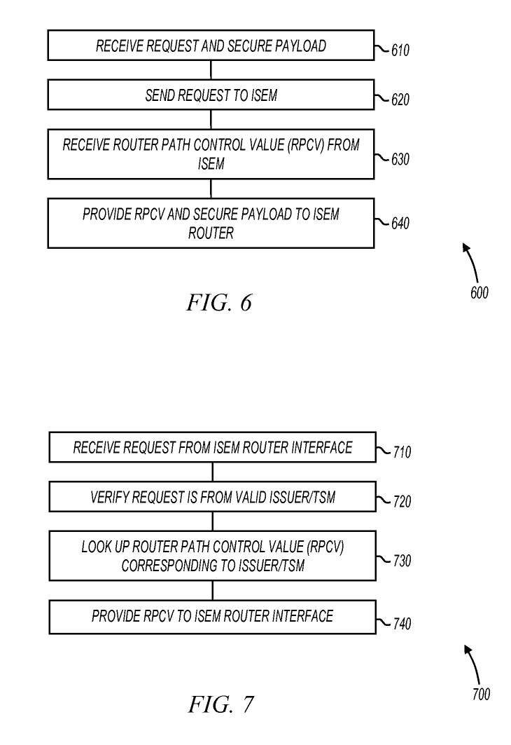

FIG. 6 shows a flowchart in accordance with various embodiments of the present invention. In some embodiments, method 600 may be performed by ISEM router interface functions 520 (FIG. 5). In some embodiments, method 600, or portions thereof, is performed by dedicated hardware, such as a state machine, and in other embodiments, method 600, or portions thereof, is performed by a controller executing software instructions. The various actions in method 600 may be performed in the order presented, in a different order, or simultaneously. Further, in some embodiments, some actions listed in FIG. 6 are omitted from method 600.

Method 600 begins at 610 in which a secure payload and a request to access a secure element are received from a TSM. The secure payload is typically encrypted with at least one encryption key. For example, the secure payload may be encrypted with a card management key (CMK) owned or managed by the TSM, and also with an issuer specific key that allows access to an issuer specific domain (ISD) within the secure element.

At 620, the request is sent to an independent secure element manager (ISEM). At 630, a router path control value (RPCV) is received from the ISEM, and at 640, the RPCV and the secure payload are provided to the ISEM router. In some embodiments, if an RPCV is not received from the ISEM, then method 600 is aborted without sending any secure payload to the ISEM router.

FIG. 7 shows a flowchart in accordance with various embodiments of the present invention. In some embodiments, method 700 may be performed by ISEM router path control value (RPCV) database and control component 530 (FIG. 5). In some embodiments, method 700, or portions thereof, is performed by dedicated hardware, such as a state machine, and in other embodiments, method 700, or portions thereof, is performed by a controller executing software instructions. The various actions in method 700 may be performed in the order presented, in a different order, or simultaneously. Further, in some embodiments, some actions listed in FIG. 7 are omitted from method 700.

Method 700 begins at 710 when a request is received from the ISEM router interface. This corresponds to ISEM RPCV database and control 530 receiving a request from ISEM router interface functions 520. The exact contents of the request are not a limitation of the present invention. In some embodiments, the request includes information identifying the issuer and/or TSM that originated the request. At 720, the request is verified as having coming from a valid issuer or TSM, and at 730, an RPCV corresponding to the issuer/TSM is looked up in the database. At 740, the RPCV is provided to the ISEM router interface.

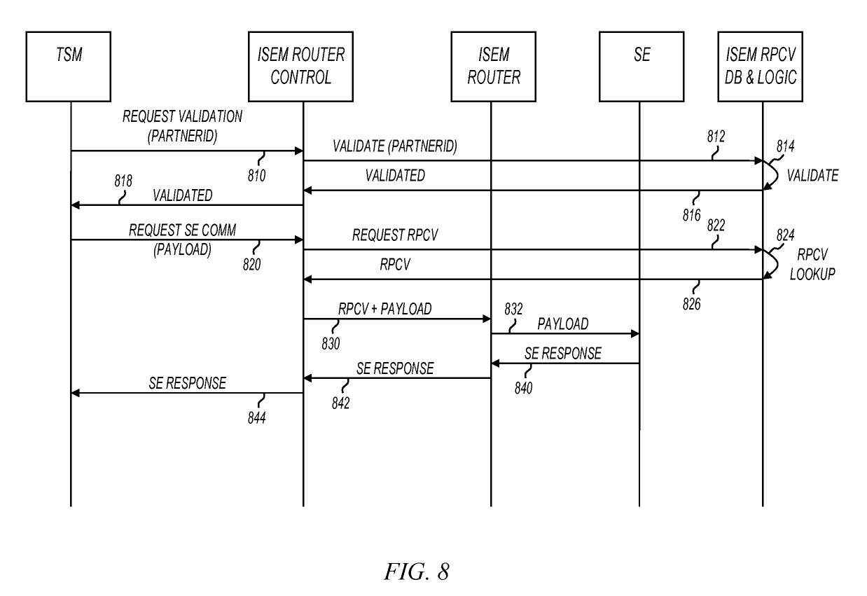

FIG. 8 shows independent secure element management (ISEM) communications in accordance with various embodiments of the present invention. At 810, a TSM sends a request to the ISEM router control to be validated. The ISEM router control forwards the request to the ISEM RPCV database and logic at 812. At 814, the ISEM RPCV database and logic validates the TSM. At this time, one or more RPCVs corresponding to the TSM are inserted into the database. The ISEM reports the TSM as validated at 816, and the ISEM router provides the validation information to the TSM at 818.

At 820, the TSM requests to communicate with a secure element and provides a secure payload. This corresponds to the TSM request and secure payload shown in FIG. 5. At 822, the ISEM router control functions forward the request to the ISEM RPCV database and logic. At 824, the ISEM RPCV database and logic looks up an RPCV corresponding to the request. The RPCV that is looked up was inserted in the database at 814. If an RPCV is found, the ISEM returns the RPCV to the ISEM router control functions at 826.

At this point, the router control functions have received the secure payload from the TSM and an RPCV from the ISEM. The router control functions provide the secure payload and the RPCV to the ISEM router at 830. The ISEM router routes the payload according to the RPCV and provides the payload to the secure element at 832. The secure element optionally provides a response at 840, which is then forwarded to the TSM at 842, 844. The communications flow shown in FIG. 8 is provided as a specific example. The various embodiments of the present invention are not limited to the specific example provided in FIG. 8.

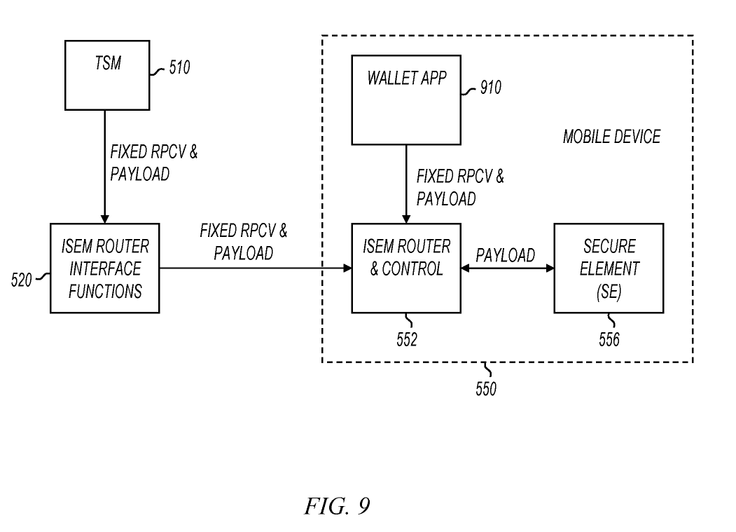

FIG. 9 shows the use of fixed router path control values (RPCVs). In some embodiments, a fixed RPCV may be released such that the ISEM need not be consulted each time it is used. The fixed RPCV may be used by one or more entities, such as TSM 510 or wallet application 910 to access non-secure information. For example, ISEM router 552 may recognize the fixed RPCV and pass simple queries such as a request for a secure element chip serial number (CSN). Also for example, ISEM router 552 may block access to more sensitive information (such as financial information stored in the secure element) when a fixed RPCV is recognized. In some embodiments, ISEM router interface functions 520 may be implemented as part of an application programming interface (API) on mobile device 550.

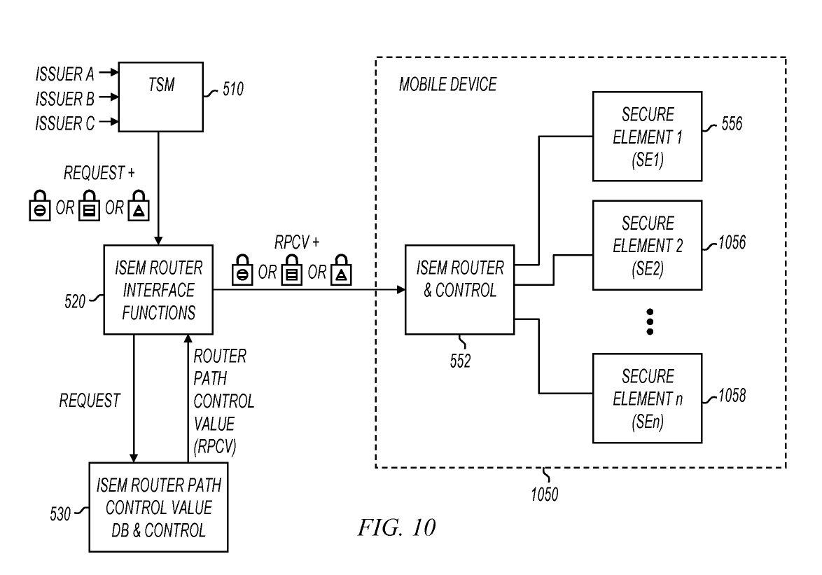

FIG. 10 shows an independent secure element manager (ISEM) controlling access to multiple secure elements in a mobile device. Mobile device 1050 includes ISEM router and control component 552 and secure elements 556, 1056, and 1058. In some embodiments, mobile device 550 also includes ISEM router interface functions 520. For example, ISEM router interface functions 520 may be implemented as part of an application programming interface (API) on mobile device 550. In other embodiments, ISEM router interface functions 520 may be resident at the ISEM along with ISEM router path control value (RPCV) database and logic 530.

In the example of FIG. 10, TSM 510 works with three issuers that each wish to provision a secure payload into one or more of secure elements 556, 1056, and 1058. TSM 510 does not have direct access to the secure elements; rather, TSM 510 requests access to the secure elements and the ISEM determines whether or not to grant that access.

In operation, TSM 510 sends a request and a secure payload to ISEM router interface functions 520. ISEM router interface functions 520 forwards the request to ISEM RPCV database and logic 530. In response to the request, ISEM RPCV database and logic 530 returns an RPCV to ISEM router interface functions 520. ISEM router interface functions 520 then forwards the RPCV and the secure payload to ISEM router and control component 552. ISEM router and control component 552 determines whether (and where) to forward the secure payload based on the RPCV.

As shown in the example system of FIG. 10, the ISEM plays a role controlling access to multiple secure elements. The ISEM controls access to the secure elements without managing encryption keys, and without taking on the fraud liability associated with key management. As shown in FIG. 10, access control by an ISEM provides scalability when a TSM wishes to access multiple secure elements.

In some embodiments, keys to each secure element are separately owned and managed by different entities. For example, a first credit card brand may control encryption keys for secure element 556, while a second credit card brand may control encryption keys for secure element 1056. Multiple secure elements and an ISEM router may allow multiple payment applications representing multiple brands and/or banks to coexist on one mobile device. Also for example, a government entity may own and/or manage encryption keys for secure element 1056, while a financial institution may own/or manage encryption keys for secure element 1058. This may allow identity applications to coexist with financial applications. Encryption keys for multiple secure elements on a single mobile device may be managed in any manner without departing from the scope of the present invention.

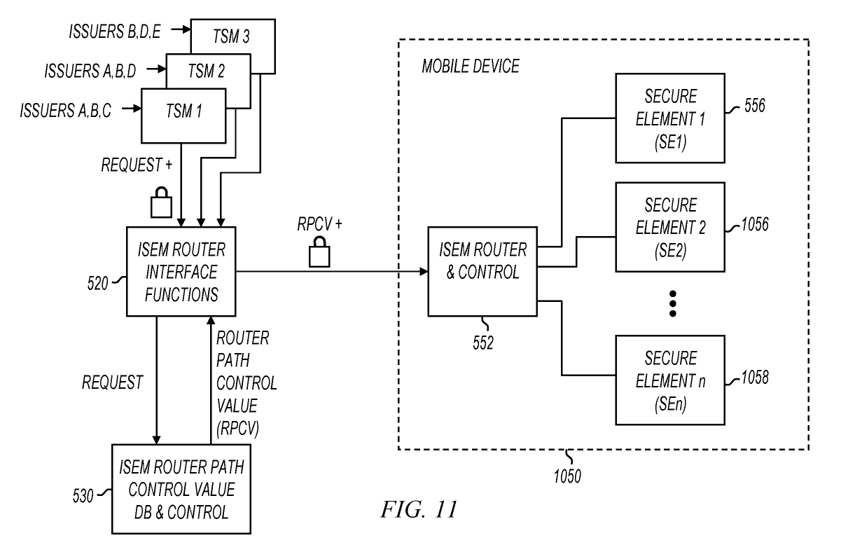

FIG. 11 shows an independent secure element manager (ISEM) controlling access by multiple TSMs to multiple secure elements in a mobile device. Mobile device 550 includes ISEM router and control component 552 and secure element 556. In some embodiments, mobile device 550 also includes ISEM router interface functions 520. For example, ISEM router interface functions 520 may be implemented as part of an application programming interface (API) on mobile device 550. In other embodiments, ISEM router interface functions 520 may be resident at the ISEM along with ISEM router path control value (RPCV) database and logic 530.

In the example of FIG. 11, TSMs 1, 2, and 3 each work with three issuers that wish to provision secure payload into one or more of secure elements 556, 1056, and 1058. TSMs 1, 2, and 3 do not have direct access to the secure elements; rather, the TSMs request access to the secure elements and the ISEM determines whether or not to grant that access.

In operation, one of TSMs 1, 2, and 3 send a request and a secure payload to ISEM router interface functions 520. ISEM router interface functions 520 forwards the request to ISEM RPCV database and logic 530. In response to the request, ISEM RPCV database and logic 530 returns an RPCV to ISEM router interface functions 520. ISEM router interface functions 520 then forwards the RPCV and the secure payload to ISEM router and control component 552. ISEM router and control component 552 determines whether (and where) to forward the secure payload based on the RPCV.

As shown in the example system of FIG. 11, the ISEM plays a role controlling access to the secure element. The ISEM controls access to the secure elements without managing encryption keys, and without taking on the fraud liability associated with key management. As shown in FIG. 11, access control by an ISEM provides scalability when multiple TSMs wish to access multiple secure elements.

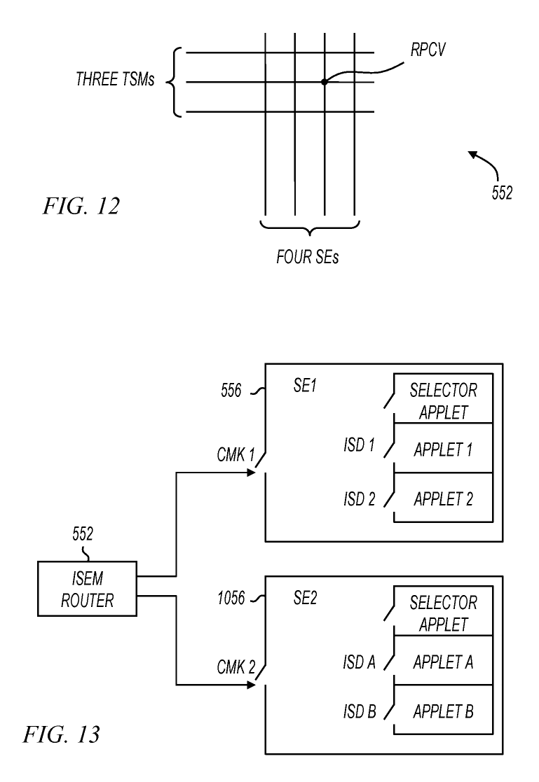

FIG. 12 shows an ISEM router modeled as a cross-point switch. ISEM router 552 is shown as a cross-point switch that can connect any of three TSMs to any of four secure elements. The received RPCV dictates which secure element is connected to a TSM for a particular secure payload. In some embodiments, any particular secure element may have multiple RPCV values that would route to it. For example, different TSMs or issuers can be associated with different RPCVs that route to the same secure element.

FIG. 13 shows multiple secure elements provisioned with multiple secure payloads. ISEM router 552 routes secure payloads to one of secure element 556 or 1056 based on the RPCV. The secure payload is encrypted with a card management key (CMK) unique to a secure element, and then each payload is typically further encrypted with an issuer specific key corresponding to an issuer specific domain (ISD) within the secure element. For example, applet 1 within secure element 556 was provisioned by issuer that controls ISD 1 and a TSM that owns CMK 1. The selector applet selects which of the remaining applets will be used during a transaction.

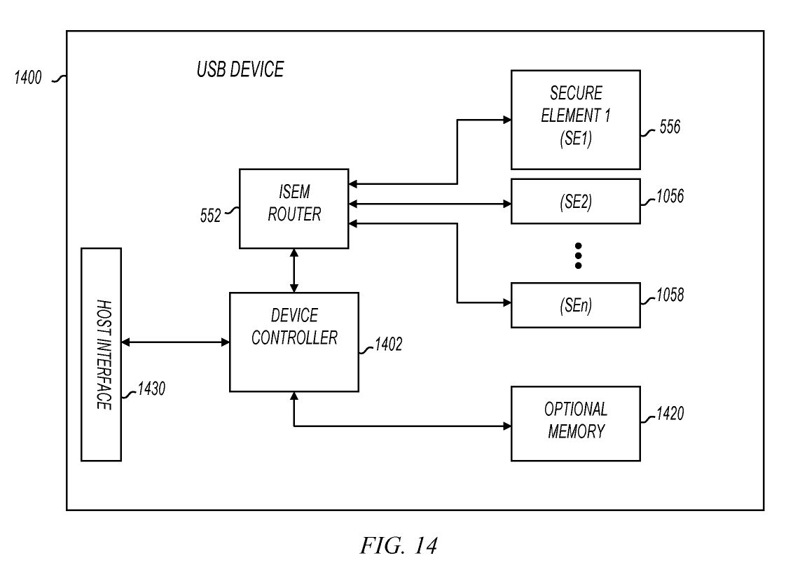

FIG. 14 shows a universal serial bus (USB) device with an ISEM router and multiple secure elements in accordance with various embodiments of the present invention. USB device 1400 includes host interface 1430, device controller 1402, ISEM router 552, optional memory 1420, and secure elements 556, 1056, and 1058. USB device 1400 may be any type of token capable of communicating with a USB slot. Further, USB device 1400 may take any form factor compatible with a USB slot. Host interface 1430 includes contacts compatible with a USB slot, and device controller 1402 is a controller capable of communicating with a host device (such as a computer) using host interface 1430.

In operation, ISEM router 552 routes secure payloads to one or more of secure elements 552, 1056, and 1058 based on the RPCV value received with the secure payload.

In some embodiments, one or more of secure elements 556, 1056, and 1058 are dual interface smartcard controllers, and one or more antennas exist on USB device 1400. Further, any number of secure elements may exist on USB device 1400 without departing from the scope of the present invention. Further, in some embodiments, ISEM router 552 functionality may be part of the device controller 1402. Also in some embodiments, ISEM router 552 may be directly connected to host interface 1430.

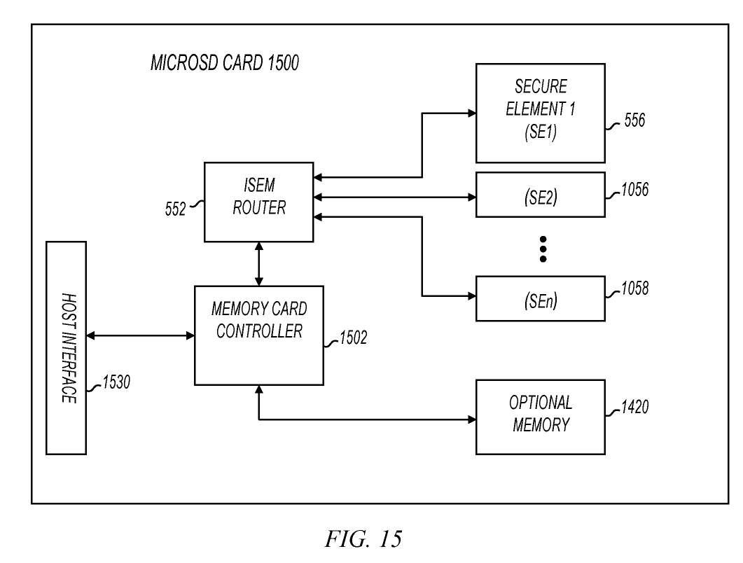

FIG. 15 shows a memory card with an ISEM router and multiple secure elements in accordance with various embodiments of the present invention. MicroSD card 1500 includes host interface 1530, memory card controller 1502, ISEM router 552, optional memory 1420, and secure elements 556, 1056, and 1058. MicroSD card 1500 may be any type of token capable of communicating with a memory slot. Further, although the memory card of FIG. 15 is shown as a microSD card, the memory card may take any form factor compatible with a memory card slot. Host interface 1530 includes contacts compatible with a memory card slot, and memory card controller 1502 is a controller capable of communicating with a host device (such as a mobile phone) using host interface 1530.

In operation, ISEM router 552 routes secure payloads to one or more of secure elements 552, 1056, and 1058 based on the RPCV value received with the secure payload.

In some embodiments, one or more of secure elements 556, 1056, and 1058 are dual interface smartcard controllers, and one or more antennas exist on microSD card 1500. Further, any number of secure elements may exist on microSD card 1500 without departing from the scope of the present invention. Further, in some embodiments, ISEM router 552 functionality may be part of memory card controller 1502. Also in some embodiments, ISEM router 552 may be directly connected to host interface 1530.

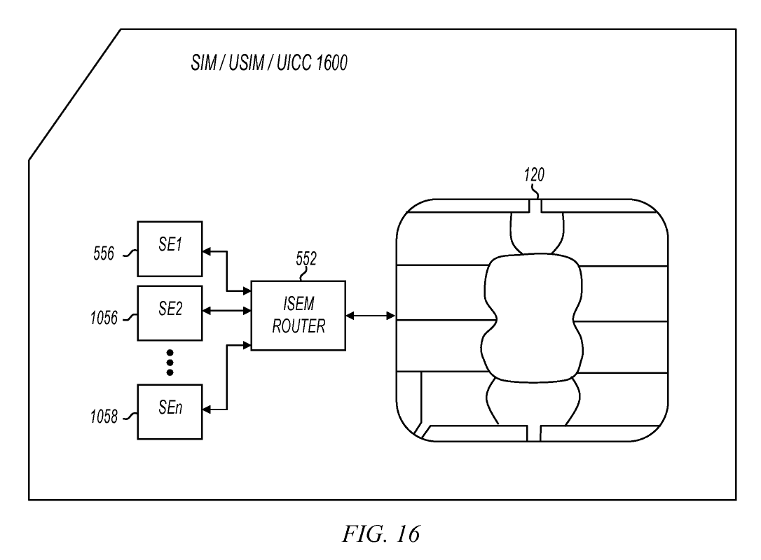

FIG. 16 shows a subscriber identity module (SIM) with an ISEM router and multiple secure elements in accordance with various embodiments of the present invention. SIM card 1600 includes contacts 120, ISEM router 552, and secure elements 556, 1056, and 1058. In operation, ISEM router 552 routes secure payloads to one or more of secure elements 552, 1056, and 1058 based on the RPCV value received with the secure payload.

In some embodiments, one or more of secure elements 556, 1056, and 1058 are dual interface smartcard controllers, and one or more antennas exist on SIM card 1600, or antenna in a mobile device is accessed using contacts 120. Further, any number of secure elements may exist on SIM card 1600 without departing from the scope of the present invention.

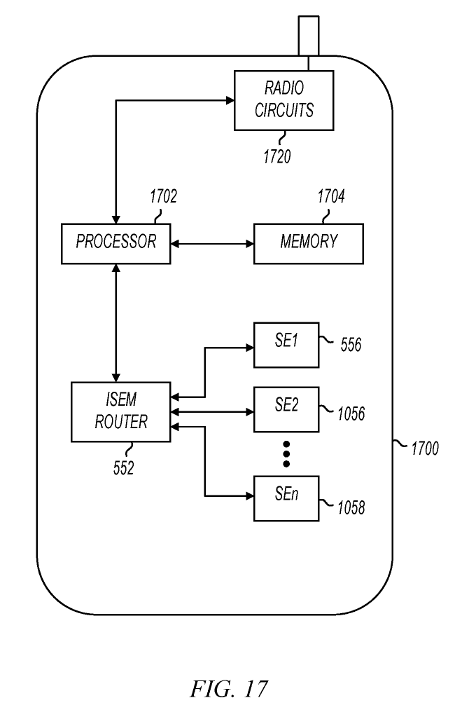

FIG. 17 shows a mobile device with an ISEM router and multiple secure elements in accordance with various embodiments of the present invention. Mobile device 1700 may be any type of mobile device capable of housing an ISEM router and one or more secure elements. For example, mobile device 1700 may be a mobile phone, a media player, a tablet computer, or the like.

Mobile device 1700 includes ISEM router 552, secure elements 556, 1056, and 1058, processor 1702, memory 1704, and radio circuits 1720. Processor 1702 may be any type of processor, and memory 1704 may be any type of memory.

Each secure element shown in FIG. 17 could be a USB or SIM or MicroSD based secure element. For example, secure element 556 may be on a microSD memory card, secure element 1056 may be on a SIM, and secure element 1058 may be on a circuit board within mobile device 1700. Further, in some embodiments, mobile device 1700 may include an ISEM router and one or more secure elements as shown, and also include a memory card in a memory card slot with further secure elements and possible another ISEM router.

Radio circuits 1720 may be any type of radio circuit. For example, radio circuits 1720 may be a cellular transceiver or may be wireless local area network radio. In some embodiments, radio circuits 1720 are omitted.

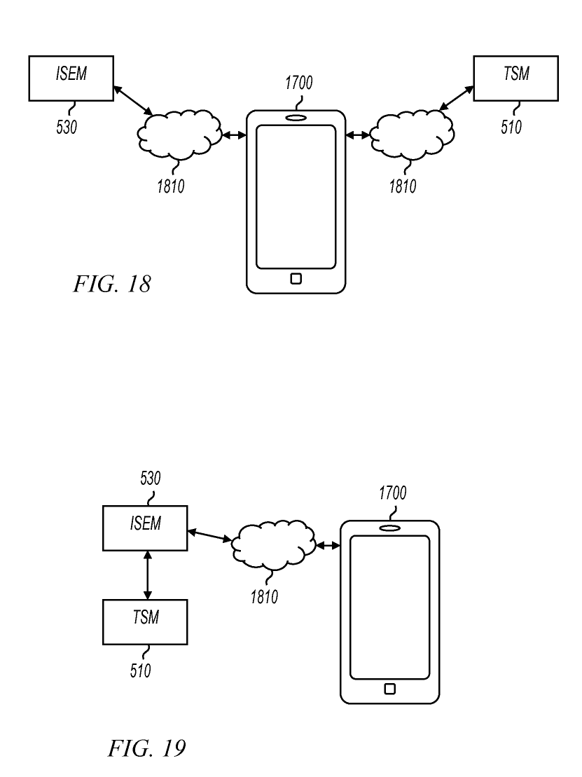

FIG. 18 shows a provisioning model in which router interface functions are included in a mobile device. Mobile device 1700 is described above with reference to FIG. 17. Mobile device 1700 includes one or more ISEM routers and one or more secure elements on a memory card, SIM card, USB device, or built-in. Any number of secure elements may coexist on mobile device 1700.

In operation, TSM 510 sends a request to communicate with a secure element and a secure payload to mobile device through network 1810. This is also referred to as over-the-air communications. Mobile device 1700 receives the request and forwards it to ISEM 530 over-the-air. This corresponds to the operation of ISEM router control functions 520, which are implemented inside mobile device 1700 in the example of FIG. 18. For example, ISEM router control functions 520 may be implemented as an application programming interface (API) within mobile device 1700.

ISEM 530 looks up an RPCV in accordance with the methods described above, and provides the RPCV back to mobile device 1700 over-the-air. Embodiments represented by FIG. 18 allow over-the-air (OTA) provisioning of multiple secure elements in one device by multiple issuers and/or TSMs.

FIG. 19 shows a provisioning model in which router interface functions are included in an ISEM. Mobile device 1700 is described above with reference to FIG. 17. Mobile device 1700 includes one or more ISEM routers and one or more secure elements on a memory card, SIM card, USB device, or built-in. Any number of secure elements may coexist on mobile device 1700.

In operation, TSM 510 sends a request to communicate with a secure element and a secure payload to ISEM 530. This may or may not be accomplished over-the-air. ISEM 530 looks up an RPCV in accordance with the methods described above, and provides the RPCV and the secure payload to mobile device 1700 over-the-air. This corresponds to the operation of both the ISEM router control functions 520, and the ISEM RPCV database and logic 530 which are both implemented inside ISEM 530 in the example of FIG. 19.

Embodiments represented by FIG. 19 allow over-the-air (OTA) provisioning of multiple secure elements in one device by multiple issuers and/or TSMs.

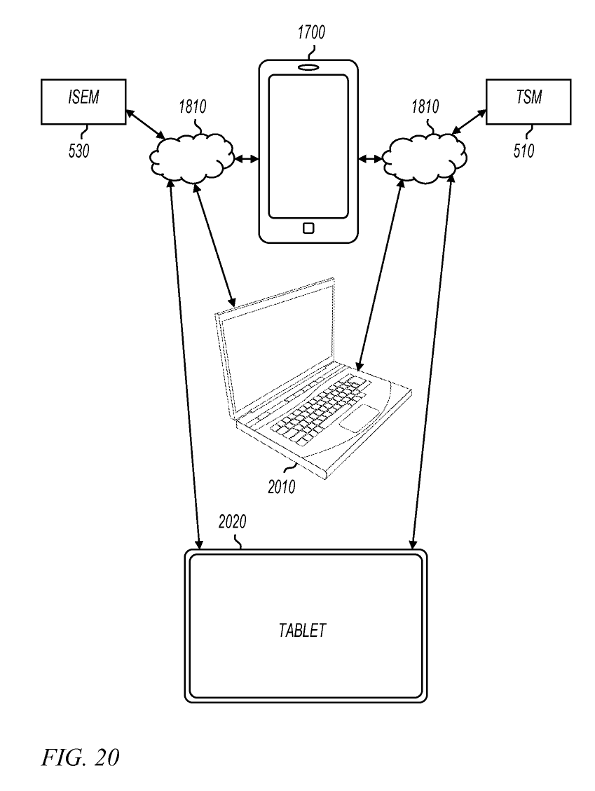

FIG. 20 shows a provisioning model in which router interface functions are included in mobile devices. The example of FIG. 20 is similar to FIG. 18 except two more devices (laptop computer 2010 and tablet computer 2020) with secure elements are also provisioned. In some embodiments, mobile device 1700, laptop computer 2010, and tablet computer 2020 are all owned by the same consumer, and the secure elements within each device are similarly provisioned. For example, a bank credit card may be provisioned in each of mobile device 1700, laptop computer 2010, and tablet computer 2020. Any number of secure elements may be provisioned with like identity information in this manner.

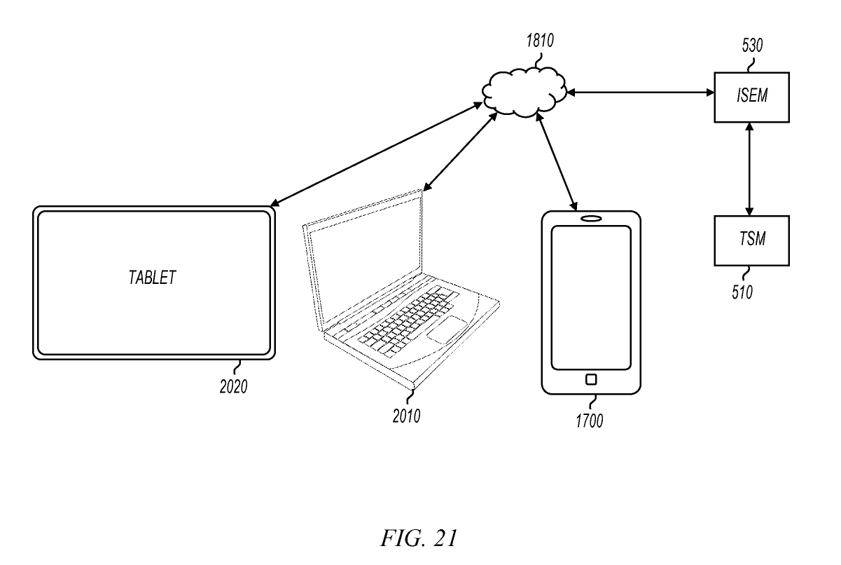

FIG. 21 shows a provisioning model in which router interface functions are included in an ISEM. The example of FIG. 21 is similar to FIG. 19 except two more devices (laptop computer 2010 and tablet computer 2020) with secure elements are also provisioned. In some embodiments, mobile device 1700, laptop computer 2010, and tablet computer 2020 are all owned by the same consumer, and the secure elements within each device are similarly provisioned. For example, a bank credit card may be provisioned in each of mobile device 1700, laptop computer 2010, and tablet computer 2020. Any number of secure elements may be provisioned with like identity information in this manner.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. An apparatus comprising:
a secure element;
an independent secure element management router to control access to the secure element based on a router path control value.

2. The apparatus of claim 1 wherein the apparatus comprises a microSD memory card.

3. The apparatus of claim 1 wherein the apparatus comprises a universal serial bus (USB) device.

4. The apparatus of claim 1 wherein the apparatus comprises a mobile phone.

5. The apparatus of claim 1 wherein the apparatus comprises a subscriber identity module (SIM).

6. The apparatus of claim 1 further comprising a plurality of secure elements.

7. The apparatus of claim 6 wherein the independent secure element management router is operable as a crosspoint switch to route secure payloads from a plurality of trusted service managers to the plurality of secure elements.

8. The apparatus of claim 6 wherein the plurality of secure elements comprise a plurality of smart card secure elements.

9. A method comprising:
receiving a secure payload originating from a trusted service manager;
receiving a router path control value originating from an independent secure element manager; and
routing the secure payload to a secure element based on the router path control value.

10. The method of claim 9 wherein routing the secure payload comprises routing the secure payload to one of a plurality of secure elements.

11. The method of claim 9 wherein routing the secure payload comprises routing the secure payload to a secure element in a microSD memory card.

12. The method of claim 9 wherein routing the secure payload comprises routing the secure payload to a secure element in a universal serial bus (USB) device.

13. The method of claim 9 wherein routing the secure payload comprises routing the secure payload to a secure element in a mobile phone.

14. The method of claim 9 wherein routing the secure payload comprises routing the secure payload to a secure element in a tablet computer.

15. The method of claim 9 wherein routing the secure payload comprises routing a secure payload that includes financial information.

16. A method comprising:
receiving a request for a trusted service manager to communicate with a secure element;
verifying the trusted service manager has been validated; and
providing a router path control value that will cause an independent secure element management (ISEM) router to route communications from the trusted service manager to the secure element.

17. The method of claim 16 wherein providing a router path control value comprises providing a router path control value that will cause the ISEM router to route communications to a secure element in a microSD memory card.

18. The method of claim 16 wherein providing a router path control value comprises providing a router path control value that will cause the ISEM router to route communications to a secure element in a mobile device.

19. The method of claim 16 wherein providing a router path control value comprises providing a router path control value that will cause the ISEM router to route communications to a secure element in a subscriber identity module (SIM).

20. The method of claim 16 wherein providing a router path control value comprises providing a router path control value that will cause the ISEM router to route communications to one of a plurality of secure elements in a mobile device.
